(19) United States
(12) Patent Application Publication
(10) Pub. No.: US 2026/0115587 A1
(43) Pub. Date: Apr. 30, 2026

(54) MASS SCALE AUDIENCE INTERACTIVE GAMEPLAY THROUGH COMPUTER VISION

(71) Applicant: Sony Interactive Entertainment Inc., Tokyo (JP)

(72) Inventors: Zade Lobo, San Mateo, CA (US); Hideaki Iwaki, San Mateo, CA (US); Kusha Sridhar, San Mateo, CA (US); Ayush Raina, San Mateo, CA (US); Hubert Lu, San Mateo, CA (US)

(21) Appl. No.: 18/932,449

(22) Filed: Oct. 30, 2024

(51) Int. Cl. A63F 13/27

(52) U.S. Cl. CPC A63F 13/27

(57) ABSTRACT

Computer vision of a large audience in an arena or stadium with a massive display (such as an arena within a hemispherical display) is fed into a machine learning (ML) model to generate game play signals based on, e.g., the number of raised hands, synchronicity of a “wave”, areas of screen focus, jumping, leaning, and high-fiving.

### FIELD

The present application relates generally to mass scale audience interactive gameplay through computer vision.

### BACKGROUND

Video may be played on very large screens in stadiums and in special purpose venues.

### SUMMARY

As understood herein, hundreds or thousands of people may view a massive display, and as further understood herein may enjoy viewing video on the display by making the video interactive with the audience.

Accordingly, an apparatus includes at least one processor system configured to receive signals from one or more cameras imaging spectator locations in a display area. The processor system is also configured to input the signals to at least one machine learning (ML) model, and present video on a large display at least in part based on output of the ML model.

In some examples, the processor system can be configured to normalize the signals from the one or more cameras for respective sizes of plural people represented by the signals such that the output of the ML model is based on the signals normalized for respective sizes of plural people.

In example embodiments the processor system may be configured to normalize the signals from the one or more cameras for empty spectator locations represented by the signals such that the output of the ML model is based on the signals normalized for respective empty spectator locations represented by the signals.

In example implementations the signals from one or more cameras imaging spectator locations in the display area represent a wave, and/or raised hands, and/or jumps, and/or high fives, and/or people leaning.

In embodiments, the output of the ML model can include a video game character action and/or a video game team action.

In non-limiting examples the processor system may be configured to configure a first event of a video game presented on the display at a first amplitude responsive to a first number of people in the display area performing a demanded action. The processor system also may be configured to configure the first event of the video game presented on the display at a second amplitude responsive to a second number of people in the display area performing the demanded action.

In some examples the processor system is configured to decompose the signals from the one or more cameras to isolate individual people in the display area, and control respective objects in the video presented on the display based on respective actions by the respective individual people. The display may be hemispherically shaped.

In another aspect, an apparatus incudes computer memory that is not a transitory signal and that in turn includes instructions executable by at least one processor system to receive at least one image of people in an arena or stadium with a massive display. The instructions are executable to implement computer vision on the image to identify actions of the people, and using a result of the computer vision, control presentation of a video game presented on the massive display.

In another aspect, a method includes using one or more cameras, imaging a crowd of people in an area of a display. The method further includes providing output images of the one or more cameras to at least one machine learning (ML) model. The method includes using output of the ML model for game play signals to control a video game on the display.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates a massive display configured as a sphere;

FIG. 3 schematically illustrates a crowd in an arena being imaged which is analyzed by computer vision to control a video game;

FIG. 4 illustrates example overall logic in example flow chart format;

FIG. 5 illustrates example training logic in example flow chart format;

FIG. 6 illustrates a crowd of people doing the “wave” with an example attendant video display being controlled thereby;

FIG. 7 illustrates a first example crowd action;

FIG. 8 illustrates a second example crowd action;

FIG. 9 illustrates a third example crowd action;

FIG. 10 illustrates a fourth example crowd action;

FIG. 11 illustrates example logic in example flow chart format for a first control feature;

FIG. 12 illustrates a display presentation related to FIG. 11;

FIG. 13 illustrates example logic in example flow chart format for a second control feature;

FIG. 14 illustrates a display presentation related to FIG. 13;

FIG. 15 illustrates example logic in example flow chart format for a third control feature;

FIG. 16 illustrates a display presentation related to FIG. 15;

FIG. 17 illustrates another example display presentation;

FIG. 18 illustrates example logic in example flow chart format for configuring a display event proportionally to the crowd performing a demanded action;

FIG. 19 illustrates yet another example display presentation;

FIG. 20 illustrates example logic in example flow chart format for normalizing computer vision analysis of the crowd for personal sizes of people in the crowd and number of occupied seats or participant locations;

FIG. 21 illustrates example logic in example flow chart format for decomposing an image of the crowd into individual participants controlling respective video objects on the display; and

FIG. 22 illustrates a display presentation consistent with FIG. 21.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single-or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

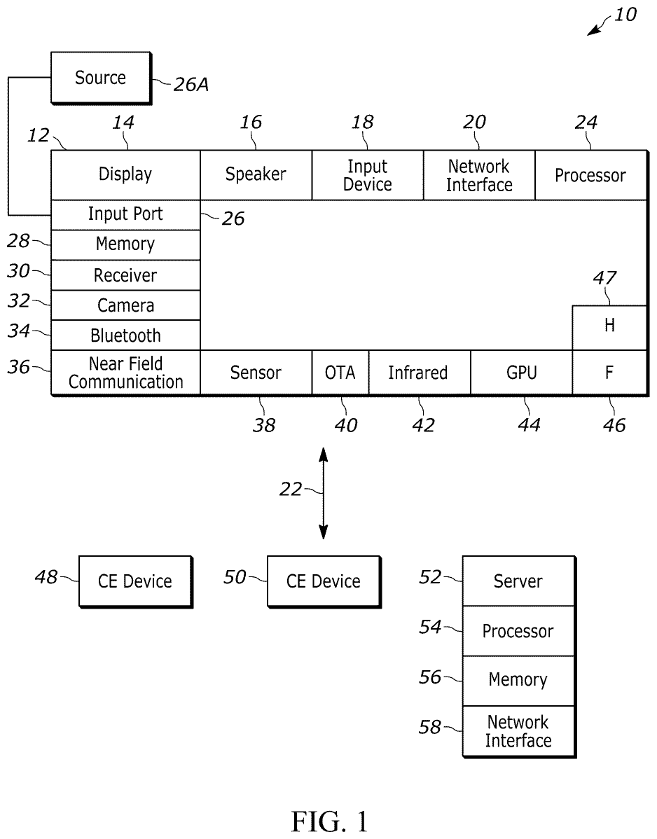

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

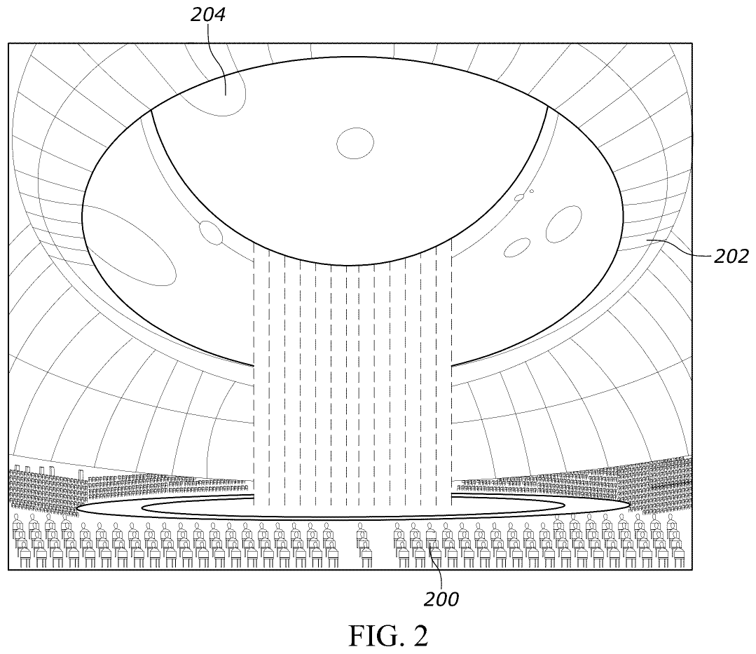

Refer now to FIG. 2. A large number of people are sitting or standing adjacent respective spectator locations such as respective seats 200 is a display area, in the example shown, a large arena-in-the-round. Overarching the display area is a massive video display 202, in the example shown, shaped as a hemisphere and presenting images 204, in the example shown, balls or planets. As set forth further below, cameras may image some or all of the spectator locations, the signals from which may be used to control or interact with the video being presented on the display 202.

Thus, FIG. 2 illustrates an environment in which computer vision of a large audience in an arena or stadium with a massive display (such as an arena within a hemispherical display) is fed into a machine learning (ML) model to generate game play signals based on, e.g., the number of raised hands, synchronicity of a “wave”, areas of screen focus, jumping, leaning, and high-fiving, as described further herein. The crowd images used for input signals to the game may be still images and/or video images.

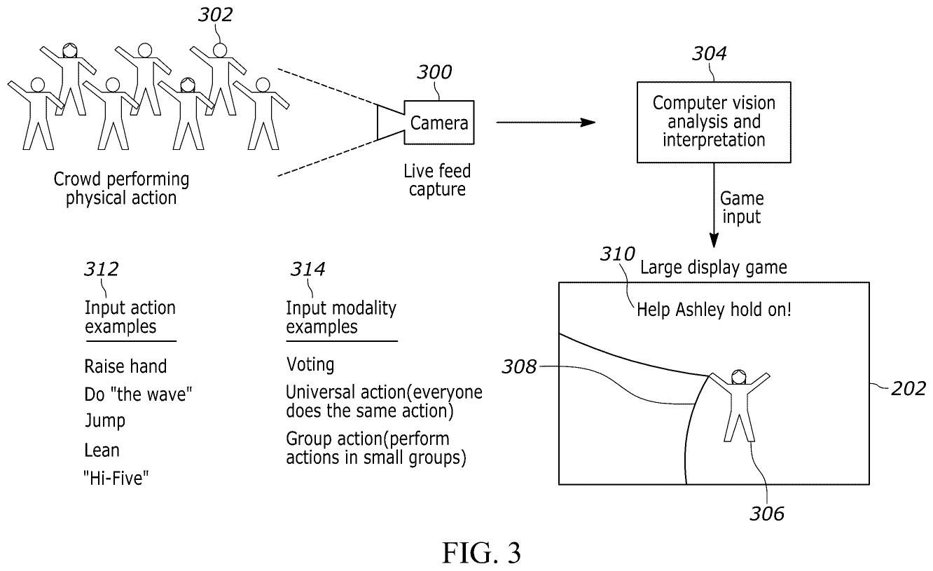

FIG. 3 provides another illustration of one or more cameras 300 imaging a crowd of people 302 in the arena. The output images of the camera 300 is sent to a computer vision module 304 to analyze and interpret the images consistent with further disclosure herein. The computer vision module 304 may be implemented by one or more machine learning (ML) models, the output of which is used for game play signals to control a video game on the display 202.

In the example shown, the video game involves a character 306 hanging from a cliff 308. The game prompts at 310 the crowd 302 to help the character hang on, in this example, by raising their hands. If enough hands are raised, the game causes the character to hold fast, but if insufficient hands are raised, the character may be caused to fall from the cliff.

FIG. 3 illustrates a first column 312 of crowd actions that can be used to generate input signals to the game while a second column 314 lists input modality action examples that the crowd actions in the first column 312 may control, such as raising hands for voting in a game, doing a wave to establish a universal action in the game, jumping, leaning, and performing high-fives for controlling various group actions in the game.

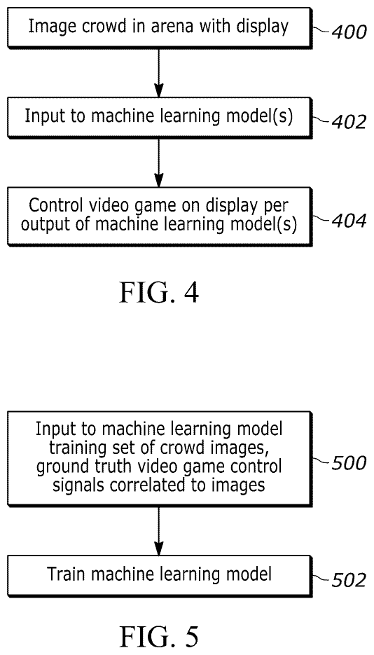

FIG. 4 illustrates how one or more ML models that may be used as the computer vision module in FIG. 2 may be used. At state 400 images of a crowd, e.g., in an arena with a massive display, are generated by one or more cameras and at state 402 input to the ML model(s). The resulting output of the ML model is used at state 404 to control one or more video games on the massive display.

FIG. 5 illustrates how one or more ML models that may be used as the computer vision module in FIG. 2 may be trained. Commencing at state 500 an input training set of data is sent to the ML model(s) to train the ML model(s) at state 502. The training set may include images of crowds along with ground truth annotations of the actions the images represent (clapping, doing “the wave”, doing “high fives”, raised hands, etc.) and/or corresponding input signals correlated to the actions.

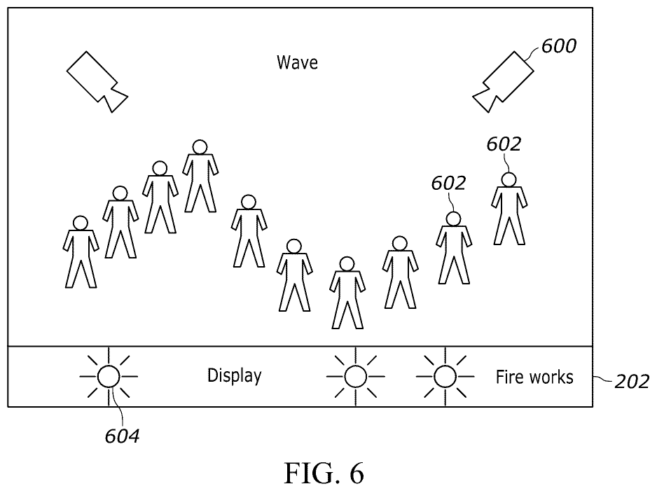

FIG. 6 illustrates plural cameras 600 imaging people 602 in an arena or other area containing a massive display such as the display 202 shown in FIG. 2. As can be appreciated in reference to FIG. 2, the people 602 are doing the “wave”, a synchronous wave-like motion of people rising from and sitting down in their seats. In response, the better the synchronicity of the wave, the more images 604 of fireworks are presented on the display 202.

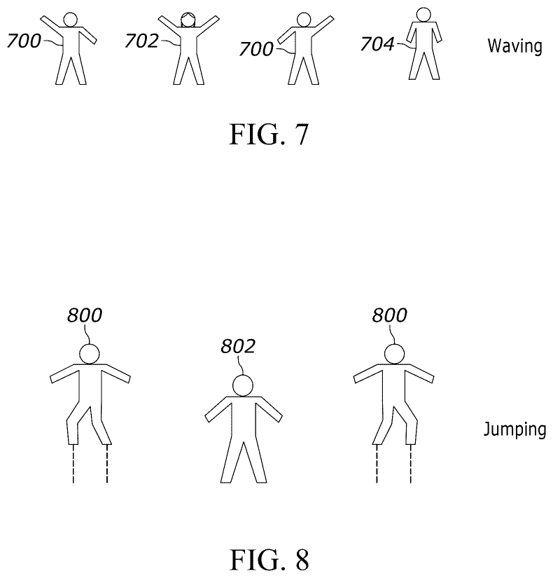

FIG. 7 illustrates an image of people in a crowd in any of the above scenarios waving their hands. As shown, two people 700 are waving only one hand, one person 702 is waving both hands, and one person 704 is not waving. Depending on its training, the ML model may determine that only a single person is waving, or that three people are waving.

FIG. 8 illustrates an image of people in a crowd in any of the above scenarios jumping. As shown, two people 800 are jumping and one person 802 is not jumping. Depending on its training, the ML model may determine that the two people jumping constitute sufficient action to precipitate a control function of the video game on the massive display, or that without everyone jumping there is not sufficient action to precipitate a control function of the video game on the massive display. Or, the ML model may vary the amplitude of the control function imposed on the game in proportion to the percentage of people doing the demanded activity.

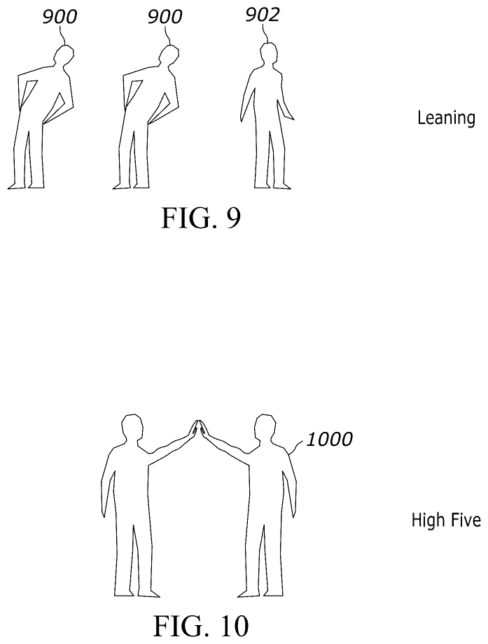

FIG. 9 illustrates an image of people in a crowd in any of the above scenarios leaning. As shown, two people 900 are leaning and one person 902 is not leaning. Depending on its training, the ML model may determine that the two people leaning constitute sufficient action to precipitate a control function of the video game on the massive display, or that without everyone leaning there is not sufficient action to precipitate a control function of the video game on the massive display. Or, the ML model may vary the amplitude of the control function imposed on the game in proportion to the percentage of people doing the demanded activity.

FIG. 10 illustrates two people 1000 performing a high five to control a video game on the massive display.

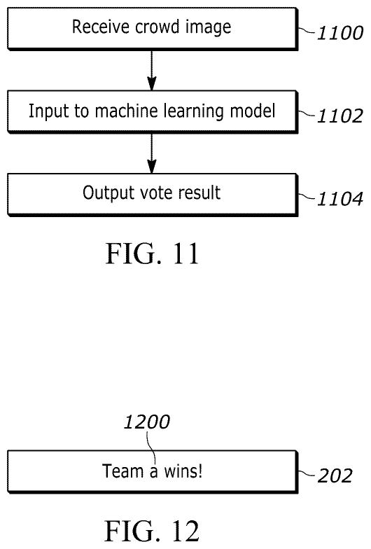

FIG. 11 illustrates example logic in example flow chart format for a control feature, in the example shown, voting and FIG. 12 illustrates a display presentation related to FIG. 11. Commencing at state 1100 the image(s) of the crowd in any of the above scenarios are received and at state 1102 input to the ML model(s). The crowd may have been prompted in this scenario to raise their hands to vote on an outcome or action a character should take in a video game. State 1104 indicates that the output of the ML model indicates a vote result. FIG. 12 illustrates that the vote result declares team A to be the winner. Other voting outcomes may control whether a character in a video game jumps or flees from a boss.

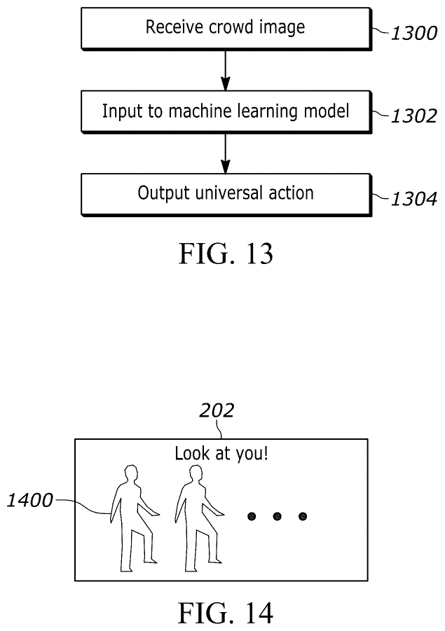

FIG. 13 illustrates example logic a control feature, in the example shown, creating a universal action to be reflected on the display 202 as shown in FIG. 14. Commencing at state 1200 the image(s) of the crowd in any of the above scenarios are received and at state 1202 input to the ML model(s). The crowd may have been prompted in this scenario to perform a line dance. State 1204 indicates that the output of the ML model indicates a universal action, in this case a line dance 1400 as shown in FIG. 14.

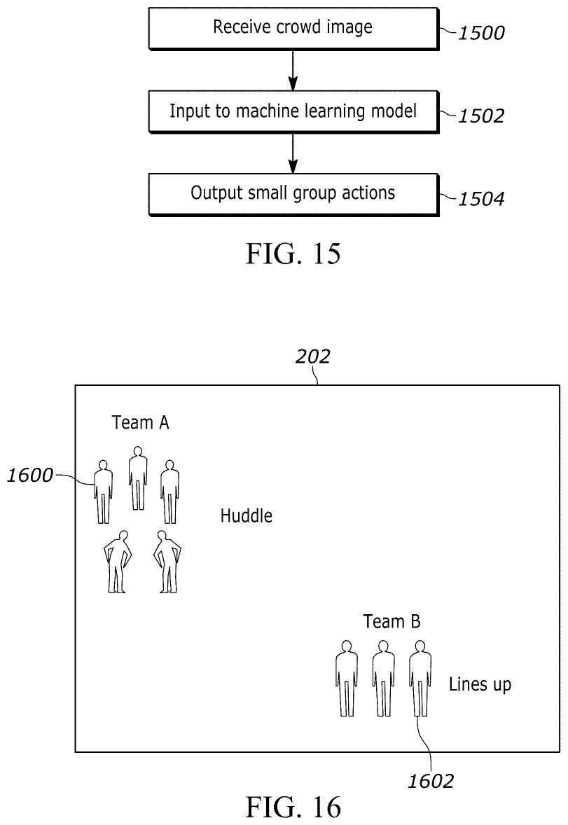

FIG. 15 illustrates example logic a control feature, in the example shown, outputting small group actions for a video game on the display 202 as shown in FIG. 16. Commencing at state 1500 the image(s) of the crowd in any of the above scenarios are received and at state 1502 input to the ML model(s). The crowd may have been prompted in this scenario to perform group actions they wish for separate teams in a video game to take. State 1504 indicates that the output of the ML model indicates group actions, in this case one team 1600 huddling and the other team 1602 lining up for a play as shown in FIG. 16. Or, in the case of teams in a video game, if a first group or people in the arena performs a demanded action (e.g., the wave) better than a second group, the video game may be controlled to show the team associated with the first group of people defeating the team associated with the second group of people.

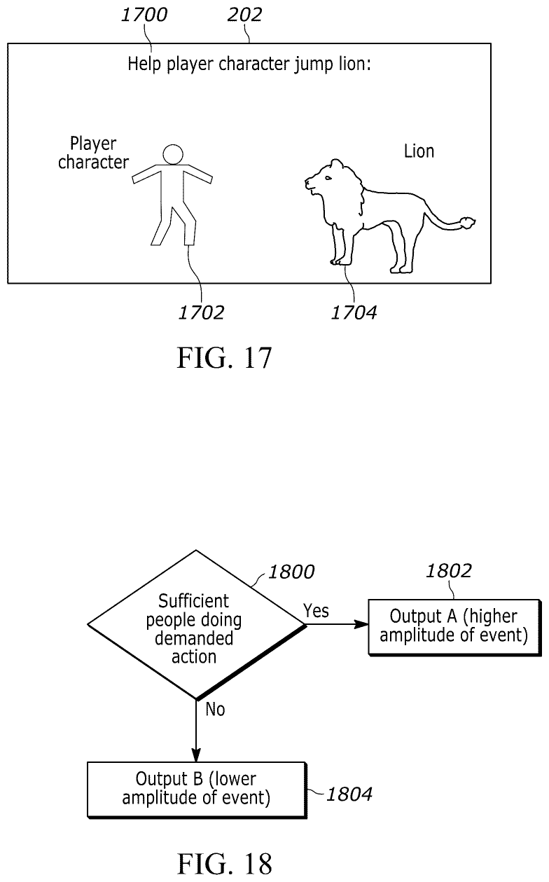

FIG. 17 illustrates that a prompt 1700 may be presented on the massive display 202 to help a player character 1702 jump over a lion 1704 in a video game. The crowd does this by jumping. If a sufficient number of people jump a sufficient height, the PC 1702 is illustrated to successfully hurdle the lion in safety. However, if a sufficient number of people fail to jump a sufficient height, the PC 1702 is illustrated to unsuccessfully or unsafely hurdle the lion.

FIG. 18 illustrates a generalized technique with FIG. 17 in mind. Commencing at state 1800, it is determined whether, using the images from the camera(s) discussed herein, whether a sufficient number of people have executed a demanded action (wave, high five, jump, etc.). If so, a higher amplitude of a game event is output at state 1802. On the other hand, responsive to an insufficient number of people executing the demanded action a lower amplitude of a game event is output at state 1804.

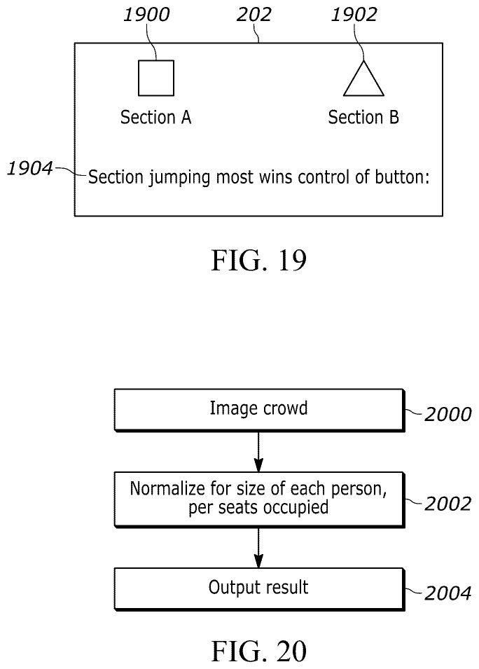

FIG. 19 illustrates further techniques. The display 202 may present two or more images of computer game control buttons 1900, 1902 (only two images shown in FIG. 19 for clarity.) As indicated in FIG. 19, a first section of people in the arena in which the display 202 is located is associated with the first control button 1900 while a second section of people in the arena in which the display 202 is located is associated with the second control button 1902. As indicated by the prompt 1904, the section more successfully performing a demanded action wins control, and its button is activated to control a game event, while the button of the other section is not activated.

FIG. 20 illustrates still further techniques. Images of the crowd in any of the scenarios herein may be taken at state 2000 and normalized at state 2002. Normalization may include normalizing imaged activity for the size of each person in the image, such that a smaller person performing a demanded action at an amplitude less than the same action performed by a larger person may be weighted equally with the larger person in determining any of the actions herein. Normalization may also or alternatively include normalizing imaged activity for the number of empty seats or spectator locations when there are no seats such that a half empty section performing a demanded activity may be weighted the same as a full section in determining any of the actions herein. Note that normalization for size and empty seats is preferably proportional. The result of the normalization is output at state 2004 for further processing consistent with disclosure herein to determine video game inputs.

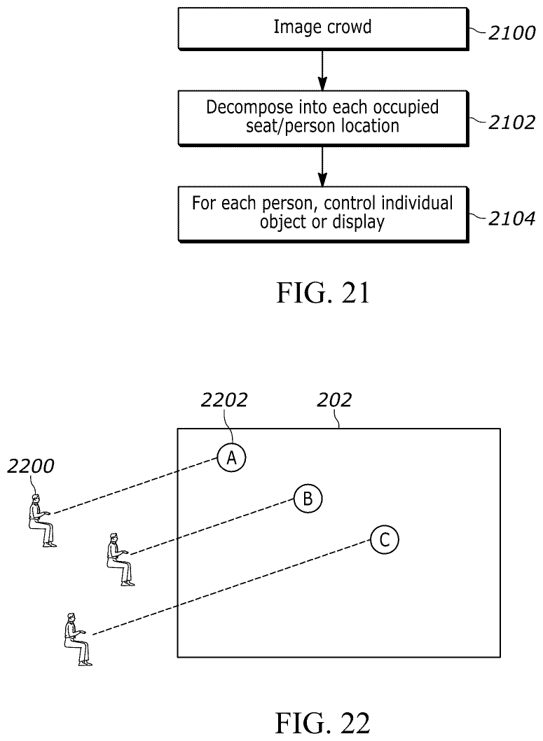

FIG. 21 illustrates still further techniques. Images of the crowd in any of the scenarios herein may be taken at state 2100 and decomposed at state 2102 into images of each occupied seat/person in the arena. The decomposed images may be input to the ML model(s) described herein to output individual control signals from each person to control corresponding individual objects in a video game on the display 202, as illustrated in FIG. 22, showing individual people 2200 controlling, via gestures, respective objects 2202 of a video game.

Additional; techniques may be presentation of an energy meter that dynamically varies as people jump or perform some other demanded more or less. Or, depending on the degree of synchronicity of performing a wave and how long it is maintained, a simulated pull on a bow and arrow object in a video game or the length a spear or rock is cast may be established.

While the particular embodiments are herein shown and described in detail, it is to be understood that the subject matter which is encompassed by the present invention is limited only by the claims.

What is claimed is:

1. An apparatus comprising:
at least one processor system configured to:
receive signals from one or more cameras imaging spectator locations in a display area;
input the signals to at least one machine learning (ML) model; and
present video on a large display at least in part based on output of the ML model.

2. The apparatus of claim 1, wherein the processor system is configured to:
normalize the signals from the one or more cameras for respective sizes of plural people represented by the signals such that the output of the ML model is based on the signals normalized for respective sizes of plural people.

3. The apparatus of claim 1, wherein the processor system is configured to:
normalize the signals from the one or more cameras for empty spectator locations represented by the signals such that the output of the ML model is based on the signals normalized for respective empty spectator locations represented by the signals.

4. The apparatus of claim 1, wherein the signals from one or more cameras imaging spectator locations in the display area represent a wave.

5. The apparatus of claim 1, wherein the signals from one or more cameras imaging spectator locations in the display area represent raised hand.

6. The apparatus of claim 1, wherein the signals from one or more cameras imaging spectator locations in the display area represent jumps.

7. The apparatus of claim 1, wherein the signals from one or more cameras imaging spectator locations in the display area represent high fives.

8. The apparatus of claim 1, wherein the signals from one or more cameras imaging spectator locations in the display area represent people leaning.

9. The apparatus of claim 1, wherein the output of the ML model comprises a video game character action.

10. The apparatus of claim 1, wherein the output of the ML model comprises a video game team action.

11. The apparatus of claim 1, wherein the processor system is configured to:
configure a first event of a video game presented on the display at a first amplitude responsive to a first number of people in the display area performing a demanded action; and
configure the first event of the video game presented on the display at a second amplitude responsive to a second number of people in the display area performing the demanded action.

12. The apparatus of claim 1, wherein the processor system is configured to:
decompose the signals from the one or more cameras to isolate individual people in the display area; and
control respective objects in the video presented on the display based on respective actions by the respective individual people.

13. The apparatus of claim 1, wherein the display is hemispherically shaped.

14. An apparatus comprising:
computer memory that is not a transitory signal and that comprises instructions executable by at least one processor system to:
receive at least one image of people in an arena or stadium with a massive display;
implement computer vision on the image to identify actions of the people, and
using a result of the computer vision, control presentation of a video game presented on the massive display.

15. The apparatus of claim 14, wherein the instructions are executable to:
normalize for respective sizes of plural people in the image such that the presentation of the video game is based on the normalize for respective sizes of plural people.

16. The apparatus of claim 14, wherein the instructions are executable to:
normalize for empty spectator locations in the image such that the presentation of the video game is based on the normalize for respective empty spectator locations.

17. The apparatus of claim 14, wherein the instructions are executable to:
configure a first event of a video game presented on the display at a first amplitude responsive to a first number of people in the display area performing a demanded action; and
configure the first event of the video game presented on the display at a second amplitude responsive to a second number of people in the display area performing the demanded action.

18. The apparatus of claim 14, wherein the instructions are executable to:
decompose the image to isolate individual people in the display area; and
control respective objects in the video presented on the display based on respective actions by the respective individual people.

19. The apparatus of claim 14, wherein the display is hemispherically shaped.

20. A method comprising:
using one or more cameras, imaging a crowd of people in an area of a display;
providing output images of the one or more cameras to at least one machine learning (ML) model; and
using output of the ML model for game play signals to control a video game on the display.
